(19) United States
(12) Patent Application Publication
(10) Pub. No.: US 2013/0241521 A1
(43) Pub. Date: Sep. 19, 2013

(54) VOLTAGE STABILIZING CIRCUIT AND ELECTRONIC DEVICE

(71) Applicant: YONG-SONG SHI, Shenzhen City (CN)

(72) Inventor: YONG-SONG SHI, Shenzhen City (CN)

(21) Appl. No.: 13/663,595

(22) Filed: Oct. 30, 2012

(30) Foreign Application Priority Data
Mar. 16, 2012 (CN) 201210069399.X

(51) Int. Cl. G05F 3/02

(52) U.S. Cl. 323/311

(57) ABSTRACT

A voltage stabilizing circuit includes an input terminal that receives an external input voltage, a three terminal voltage regulator including an input pin and an output pin; and a voltage reduction unit. The voltage reduction unit reduces the external input voltage and outputs the reduced external input voltage to the input pin. The three terminal voltage regulator regulates the reduced external input voltage to a stabilized supply voltage, and outputs the stabilized supply voltage through the output pin for powering a load.

### BACKGROUND

1. Technical Field

The disclosed embodiments relate to a voltage stabilizing circuit and an electronic device.

2. Description of Related Art

A three terminal voltage regulator includes an input pin and an output pin. The input pin receives an external input voltage. The three terminal voltage regulator regulates the external input voltage to a stabilized supply voltage, and outputs the stabilized supply voltage through the output pin. However, sometimes, the external input voltage may be larger than a rated voltage of the three terminal voltage regulator, causing the three terminal voltage regulator to malfunction or be damaged.

One solution to the above problems, is to provide a three terminal voltage regulator having a higher rated voltage. However, the maximum rated power of the three terminal voltage regulator is limited, because the rated voltage of the three terminal voltage regulator is high, the output current of the updated three terminal voltage regulator may be too small to power the load.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout one views.

The FIGURE is a block diagram of an electronic device in accordance with one embodiment.

### DETAILED DESCRIPTION

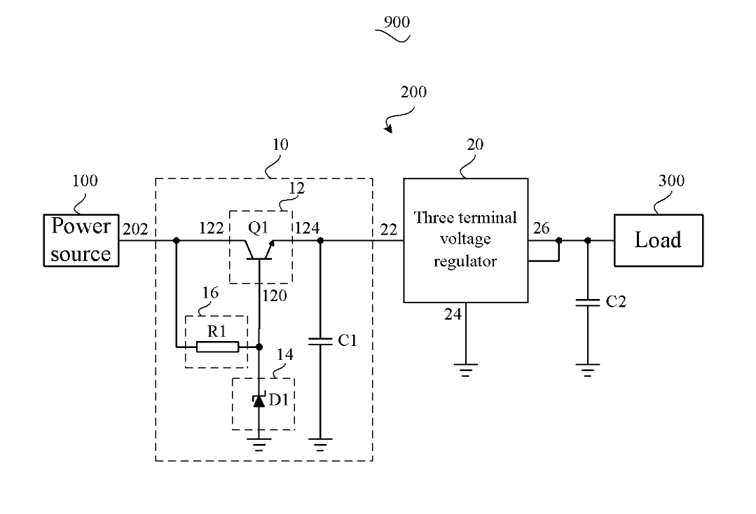

Referring to FIG. 1, an electronic device 900 includes a power source 100, a load 300, and a voltage stabilizing circuit 200 connected between the power source 100 and the load 300. The power source 100 outputs an external input voltage.

The voltage stabilizing circuit 200 includes an input terminal 202, a voltage reduction unit 10, and a three terminal voltage regulator 20. The input terminal 202 receives the external input voltage from the power source 100. The three terminal voltage regulator 20 includes an input pin 22, a ground pin 24 and an output pin 26, the ground pin 24 is grounded. The voltage reduction unit 10 receives the external input voltage from the input terminal 202, reduces the external input voltage, and outputs the reduced external input voltage to the input pin 22. In this embodiment, the reduced external input voltage is a stabilized value.

The three terminal voltage regulator 20 regulates the reduced external input voltage to a stabilized supply voltage, and outputs the stabilized supply voltage through the output pin 26 for powering the load 300. In this embodiment, the external input voltage is larger than a rated voltage of the three terminal voltage regulator 20.

In detail, the voltage reduction unit 10 includes a switch element 12, a voltage stabilizing element 14, and a current limiting element 16. The switch element 12 includes a control terminal 120, a first conducting terminal 122 connected to the input terminal 202, and a second conducting terminal 124 connected to the input pin 22. One end of the voltage stabilizing element 14 is connected to the control terminal 120, the other end of the voltage stabilizing element 14 is grounded. One end of the current limiting element 16 is connected to the first conducting terminal 122, the other end of the current limiting element 16 is connected to the control terminal 120.

When the external input voltage is larger than a predetermined voltage, a first stabilizing voltage is generated across the voltage stabilizing element 14 and the switch element 12 is turned on to generate a second stabilizing voltage between the control terminal 120 and the second conducting terminal 124. Therefore, the reduced external input voltage is equal to a subtraction of the second stabilizing voltage from the first stabilizing voltage and stability is maintained.

In this embodiment, the voltage stabilizing element 14 is a zener diode D1, an anode of the zener diode D1 is grounded, a cathode of the zener diode D1 is connected to the control terminal 120; the predetermined voltage is equal to a zener voltage of the zener diode D1, and the first stabilizing voltage is equal to the zener voltage. For example, when the external input voltage is larger than 15 volts, 15 volts is generated across the zener diode D1.

In this embodiment, the switch element 12 is a transistor Q1, a base of the transistor Q1 is the control terminal 120, a collector of the transistor Q1 is the first conducting terminal 122; an emitter of the transistor Q1 is the second conducting terminal 124. The transistor Q1 is a NPN type bipolar junction transistor.

In this embodiment, the current limiting element 16 is a resistor R1.

The voltage stabilizing circuit 200 further includes a first capacitor C1 and a second capacitor C2. One end of the first capacitor C1 is connected to the input pin 22, the other end of the first capacitor C1 is grounded. One end of the second capacitor C2 is connected to the output pin 26, the other end of the second capacitor C2 is grounded.

In the voltage stabilizing circuit 200, because the external input voltage is reduced by the voltage reduction unit 10 and the reduced external input voltage is supplied to the input pin of the three terminal voltage regulator 20, the rated voltage of the three terminal voltage regulator 20 can be small; even if the maximum rated power of the three terminal voltage regulator 20 is limited, the output current of the three terminal voltage regulator 20 is still enough to power the load 300.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. A voltage stabilizing circuit, comprising:
an input terminal that receives an external input voltage from a power source;
a three terminal voltage regulator comprising an input pin and an output pin; and
a voltage reduction unit that reduces the external input voltage and outputs the reduced external input voltage to the input pin;
wherein the three terminal voltage regulator regulates the reduced external input voltage to a stabilized supply voltage, and outputs the stabilized supply voltage through the output pin for powering a load.

2. The voltage stabilizing circuit of claim 1, wherein the reduced external input voltage is a stabilized value.

3. The voltage stabilizing circuit of claim 1, wherein the external input voltage is larger than a rated voltage of the three terminal voltage regulator.

4. The voltage stabilizing circuit of claim 1, wherein the three terminal voltage regulator further comprises a ground pin, and the ground pin is grounded.

5. The voltage stabilizing circuit of claim 1, wherein the voltage reduction unit comprises a voltage stabilizing element, a current limiting element, and a switch element; the switch element comprises a control terminal, a first conducting terminal connected to the input terminal, and a second conducting terminal connected to the input pin; one end of the voltage stabilizing element is connected to the control terminal, the other end of the voltage stabilizing element is grounded; one end of the current limiting element is connected to the first conducting terminal, the other end of the current limiting element is connected to the control terminal; when the external input voltage is larger than a predetermined voltage, a first stabilizing voltage is generated across the voltage stabilizing element and the switch element is turned on to generate a second stabilizing voltage between the control terminal and the second conducting terminal.

6. The voltage stabilizing circuit of claim 5, wherein the voltage stabilizing element is a zener diode, an anode of the zener diode is grounded, a cathode of the zener diode is connected to the control terminal; the predetermined voltage is equal to a zener voltage of the zener diode, and the first stabilizing voltage is equal to the zener voltage.

7. The voltage stabilizing circuit of claim 5, wherein the switch element is a transistor, a base of the transistor is the control terminal, a collector of the transistor is the first conducting terminal; an emitter of the transistor is the second conducting terminal.

8. The voltage stabilizing circuit of claim 5, wherein the reduced external input voltage is equal to difference between the second stabilizing voltage and the first stabilizing voltage.

9. The voltage stabilizing circuit of claim 1, further comprising a first capacitor, one end of the first capacitor is connected to the input pin, the other end of the first capacitor is grounded.

10. The voltage stabilizing circuit of claim 1, further comprising a second capacitor, one end of the second capacitor is connected to the output pin, the other end of the second capacitor is grounded.

11. An electronic device, comprising:
a power source that outputs an external input voltage;
a load; and
a voltage stabilizing circuit, wherein the voltage stabilizing circuit comprises:
an input terminal that receives the external input voltage;
a three terminal voltage regulator comprising an input pin and an output pin; and
a voltage reduction unit connected to the input terminal, wherein the voltage reduction unit reduces the external input voltage and outputs the reduced external input voltage to the input pin;
wherein the three terminal voltage regulator regulates the reduced external input voltage to a stabilized supply voltage, and outputs the stabilized supply voltage through the output pin for powering the load.

12. The electronic device of claim 11, wherein the reduced external input voltage is a stabilized value.

13. The electronic device of claim 11, wherein the external input voltage is larger than a rated voltage of the three terminal voltage regulator.

14. The electronic device of claim 11, wherein the three terminal voltage regulator further comprises a ground pin, and the ground pin is grounded.

15. The electronic device of claim 11, wherein the voltage reduction unit comprises a voltage stabilizing element, a current limiting element, and a switch element; the switch element comprises a control terminal, a first conducting terminal connected to the input terminal, and a second conducting terminal connected to the input pin; one end of the voltage stabilizing element is connected to the control terminal, the other end of the voltage stabilizing element is grounded; one end of the current limiting element is connected to the first conducting terminal, the other end of the current limiting element is connected to the control terminal; when the external input voltage is larger than a predetermined voltage, a first stabilizing voltage is generated across the voltage stabilizing element and the switch element is turned on to generate a second stabilizing voltage between the control terminal and the second conducting terminal.

16. The electronic device of claim 15, wherein the voltage stabilizing element is a zener diode, an anode of the zener diode is grounded, a cathode of the zener diode is connected to the control terminal; the predetermined voltage is equal to a zener voltage of the zener diode, and the first stabilizing voltage is equal to the zener voltage.

17. The electronic device of claim 15, wherein the switch element is a transistor, a base of the transistor is the control terminal, a collector of the transistor is the first conducting terminal; an emitter of the transistor is the second conducting terminal.

18. The electronic device of claim 15, wherein the reduced external input voltage is equal to a subtraction of the second stabilizing voltage from the first stabilizing voltage.

19. The electronic device of claim 11, further comprising a first capacitor, one end of the first capacitor is connected to the input pin, the other end of the first capacitor is grounded.

20. The electronic device of claim 11, further comprising a second capacitor, one end of the second capacitor is connected to the output pin, the other end of the second capacitor is grounded.
